(19) United States
(12) Patent Application Publication
(10) Pub. No.: US 2016/0110645 A1
(43) Pub. Date: Apr. 21, 2016

(54) SYSTEM AND METHOD FOR DYNAMICALLY UPDATING EVENT CONFIGURATION RULE FOR PROCESSING COMPLEX EVENT

(71) Applicant: Korea Institute of Science and Technology Information, Daejeon (CN)

(72) Inventors: Taehong Kim, Daejeon (KR); Chang Hoo Jeong, Daejeon (KR); Jung Ho Um, Jeollabuk-do (KR); Seungwoo Lee, Daejeon (KR); Hanmin Jung, Daejeon (KR); Won Kyung Sung, Daejeon (KR)

(21) Appl. No.: 14/571,738

(22) Filed: Dec. 16, 2014

(30) Foreign Application Priority Data
Oct. 17, 2014 (KR) 10-2014-0140577

(51) Int. Cl. G06N 5/02; G06F 9/54

(52) U.S. Cl. CPC G06N 5/025; G06F 9/542

(57) ABSTRACT

A system and method dynamically updates an event configuration rule for processing a complex event. The system for dynamically updating an event configuration rule for processing a complex event includes an analysis unit configured to analyze an event configuration rule, change a redundant factor to a new virtual rule node, and generate an event rule by combining the new virtual rule node with a non-redundant factor and an update unit configured to sequentially compare the new virtual rule node with a set of previously stored virtual rule nodes and segment and reconfigure the new virtual rule node or the set of virtual rule nodes based on a result of the comparison.

### CROSS REFERENCE TO RELATED APPLICATION

The present application claims the benefit of Korean Patent Application No. 10-2014-0140577 filed in the Korean Intellectual Property Office on Oct. 17, 2014, the entire contents of which are incorporated herein by reference.

### BACKGROUND OF THE INVENTION

1. Technical Field

The present invention relates to a system and method for dynamically updating an event configuration rule for processing a complex event and, more particularly, to a system and method for dynamically updating an event configuration rule for processing a complex event, wherein an event configuration rule that is frequently used to reuse an event configuration rule used to process a complex event is configured and templated in the form of a virtual rule nodes.

2. Description of the Related Art

Devices supporting a high-performance processing function, such as smart phones and tablet PCs, are widely spread, and a variety of types of services for such devices, such as an SNS service and a cloud computing service, are activated. Accordingly, a need for a technology for processing a large amount of data in real time is increased.

A real-time event processing technology is usefully used to support flexible and rapid decision making and to capture a business opportunity through a complicated data pattern in various fields in which a large amount of data is generated.

Although various graph analyses and schemes are introduced in order to rapidly analyze suddenly increasing data and immediately use the analyzed data, a processing system for processing the amount of data that is gradually increased and a computational load of an analysis scheme that becomes complicated in real time is not present.

There is an attempt to apply a complex event processing system for merging events extracted from input data and rapidly calculating the merged event to big data, but an increasing amount of data and calculation logic are not overcome. Furthermore, it is not easy to write an event processing rule.

In order to overcome such problems and guarantee a rapid response speed, there is a need to develop a technology capable of rapidly processing only data that belongs to a large amount of data and that is required for user query processing, previously calculating a result of a repeated query, avoiding redundancy processing based on the calculated result, and performing dynamical update when a user query is added.

Furthermore, there is a difficulty in that an event constructor has to write a complicated event configuration in an event processing language in order to configure events derived from various resources according to a user demand and to use the configured events in processing a complex event.

Furthermore, a conventional method for processing a complex event is disadvantageous in that recalculation is required every time because a repeated result cannot be reused.

### PRIOR ART DOCUMENT

### Patent Document

A prior art 1: Korean Patent Application Publication No. 2013-0059731 entitled “Real Time Logic Processing Framework System, Method Thereof and Recordable Medium Storing the Method”

### SUMMARY OF THE INVENTION

Accordingly, the present invention has been made keeping in mind the above problems occurring in the prior art, and an object of the present invention is to provide a system and method for dynamically updating an event configuration rule for processing a complex event, wherein an event configuration rule that is frequently used to reuse an event configuration rule used to process a complex event is configured and templated in the form of a virtual rule nodes.

In accordance with an aspect of the present invention, there is provided a system for dynamically updating an event configuration rule for processing a complex event, including an analysis unit configured to analyze an event configuration rule, change a redundant factor to a new virtual rule node, and generate an event rule by combining the new virtual rule node with a non-redundant factor, and an update unit configured to sequentially compare the new virtual rule node with a set of previously stored virtual rule nodes and segment and reconfigure the new virtual rule node or the set of virtual rule nodes based on a result of the comparison.

The system for dynamically updating an event configuration rule for processing a complex event may further include a virtual node storage unit configured to store the virtual rule node of a redundant event configuration rule.

The analysis unit may search for a common sub-graph based on the number and IDs of adjacent nodes in each node of the graph data of the event configuration rule and use the retrieved common sub-graph as the redundant factor.

The update unit may segment and reconfigure a corresponding virtual rule node if the new virtual rule node is present in the set of virtual rule nodes. The update unit may add the new virtual rule node to the set of virtual rule nodes if the new virtual rule node is not present in the set of virtual rule nodes.

In accordance with another aspect of the present invention, there is provided a method for dynamically updating an event configuration rule for processing a complex event, including analyzing an event configuration rule, changing a redundant factor to a new virtual rule node, and generating an event rule by combining the new virtual rule node with a non-redundant factor, and sequentially comparing the new virtual rule node with a set of previously stored virtual rule nodes and segmenting and reconfiguring the new virtual rule node or the set of virtual rule nodes based on a result of the comparison.

Analyzing the event configuration rule, changing the redundant factor to the new virtual rule node, and generating the event rule by combining the new virtual rule node with the non-redundant factor may include searching for a common sub-graph based on the number and IDs of adjacent nodes in each node of the graph data of the event configuration rule and changing the retrieved common sub-graph to the new virtual rule node, and generating the event rule by combining the new virtual rule node with the non-redundant factor of the graph data.

In accordance with yet another aspect of the present invention, there is provided a computer-readable recording medium on which a method for dynamically updating an event configuration rule for processing a complex event has been recorded in a program form. The method includes analyzing an event configuration rule, changing a redundant factor to a new virtual rule node, and generating an event rule by combining the new virtual rule node with a non-redundant factor, and sequentially comparing the new virtual rule node with a set of previously stored virtual rule nodes and segmenting and reconfiguring the new virtual rule node or the set of virtual rule nodes based on a result of the comparison.

### BRIEF DESCRIPTION OF THE DRAWINGS

FIG. 1 is a diagram illustrating a system for dynamically updating an event configuration rule for processing a complex event in accordance with an embodiment of the present invention;

FIG. 2 is a diagram illustrating a method for dynamically updating an event configuration rule for processing a complex event in accordance with an embodiment of the present invention; and

FIGS. 3 to 5 are exemplary diagrams illustrating the method for dynamically updating an event configuration rule.

### DESCRIPTION OF REFERENCE NUMERALS

110: analysis unit
120: update unit
130: virtual node storage unit
140: complex event processing unit

### DETAILED DESCRIPTION

Hereinafter, a system and method for dynamically updating an event configuration rule for processing a complex event in accordance with embodiments of the present invention are described in detail below with reference to the accompanying drawings. The embodiments to be described are provided in order for those skilled in the art to easily understand the technical spirit of the present invention, and the present invention is not limited to the embodiments. Furthermore, matters represented in the accompanying drawings have been diagrammed in order to easily describe the embodiments of the present invention, and the matters may be different from forms that are actually implemented.

Each of elements to be described herein is only an example for implementing the embodiments of the present invention. Accordingly, in other implementations of the present invention, different elements may be used without departing from the spirit and scope of the present invention. Furthermore, each element may be purely formed of a hardware or software element, but may also be implemented using a combination of various hardware and software elements that perform the same function.

Furthermore, an expression that some elements are “included” is an expression of an “open type”, and the expression simply denotes that the corresponding elements are present, but it should not be understood that additional elements are excluded.

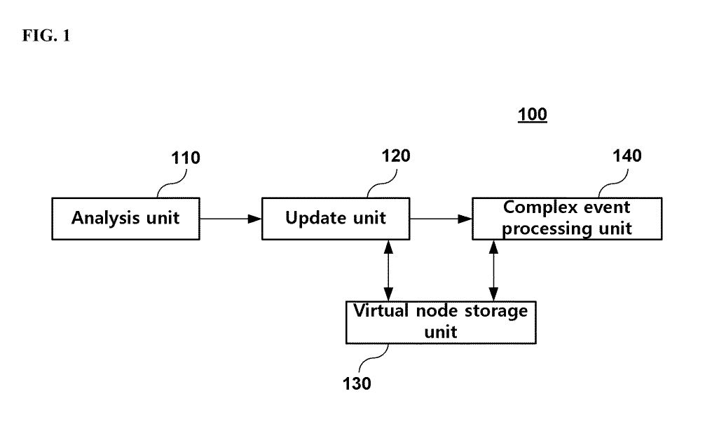

FIG. 1 is a diagram illustrating a system for dynamically updating an event configuration rule for processing a complex event in accordance with an embodiment of the present invention.

Referring to FIG. 1, the system 100 for dynamically updating an event configuration rule for processing a complex event includes an analysis unit 110, an update unit 120, and a storage unit 130.

The analysis unit 110 analyzes an event configuration rule, changes a redundant factor to a new virtual rule node based on a result of the analysis, and generates an event rule by combining the redundant factor with a non-redundant factor.

That is, the analysis unit 110 searches the graph data of an event configuration rule for a common sub-graph and determines that a redundant factor is present if, as a result of the search, a common sub-graph is present. In this case, the analysis unit 110 searches for a common sub-graph based on the number and IDs of adjacent nodes in each node of the graph data of the event configuration rule. Furthermore, the common partial graph may mean a graph that may be frequently used and recycled.

The update unit 120 sequentially compares a new virtual rule node, generated by the analysis unit 110, with a set of virtual rule nodes stored in the storage unit 130 and segments and reconfigures the new virtual rule node or the set of virtual rule nodes based on a result of the comparison.

That is, if a new virtual rule node is present in a set of virtual rule nodes, the update unit 120 segments and reconfigures a corresponding virtual rule node. If a new virtual rule node is not present in a set of virtual rule nodes, the update unit 120 adds the new virtual rule node to the set of virtual rule nodes.

The storage unit 130 stores a virtual rule node corresponding to a redundant event configuration rule. In this case, the virtual rule node is business logic that may be repeatedly used and that has been defined in a single pattern form. That is, independent event configuration rules configured to perform a specific function are defined as a single virtual rule node. If a corresponding function is required, a corresponding virtual rule node may be immediately applied without a need to configure independent event configuration rules.

The system configured as described above may further include a complex event processing unit 140.

The complex event processing unit 140 derives results by processing a real-time event stream through a previously defined event configuration rule and a virtual rule node stored in the virtual node storage unit 130. In this case, the complex event processing unit 140 uses a real-time question/response protocol of a synchronous method. Accordingly, data stream processing results may be synchronously obtained, and a matching result may be provided in response to a real-time event from a user.

The complex event processing unit 140 may use a variety of types of queues and processors for event processing. Each queue and each processor perform all the works in memory. Accordingly, there is an advantage in that a load of a complex event processing system server can be minimized and data consistency can be maintained through such a process.

The complex event processing unit 140 functions to make collected data a business event and to process the business event and may perform general-purpose processing on a variety of types of event attributes. Data extracted from an event source is used to perform event determination and actions through various processors and queue works.

Each of the analysis unit 110, the update unit 120, the storage unit 130, and the complex event processing unit 140 may be implemented by a processor required to execute a program on a computing apparatus. As described above, the analysis unit 110, the update unit 120, the storage unit 130, and the complex event processing unit 140 may be implemented using physically independent elements and may be implemented in a form in which they are functionally separated within a single processor.

The elements that may be included in the system 100 may be implemented by hardware, software, or a combination of them, and two or more of the elements may be implemented by a single piece of hardware or software.

The system 100 may communicate with other electronic devices according to various communication standards, and it may be implemented through an electronic device capable of performing a variety of types of data processing operations. For example, the system 100 may be implemented in the form of a server apparatus or may be implemented in the form of various electronic devices in addition to such a server apparatus form. Furthermore, the system 100 may be implemented in the form of a single electronic device or may be implemented in a form in which two or more electronic devices are combined.

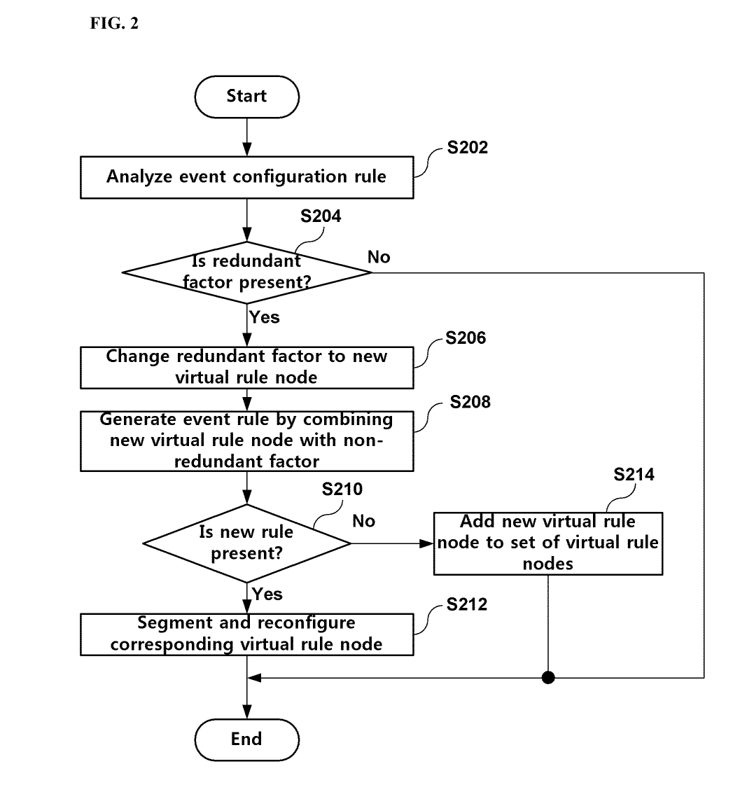

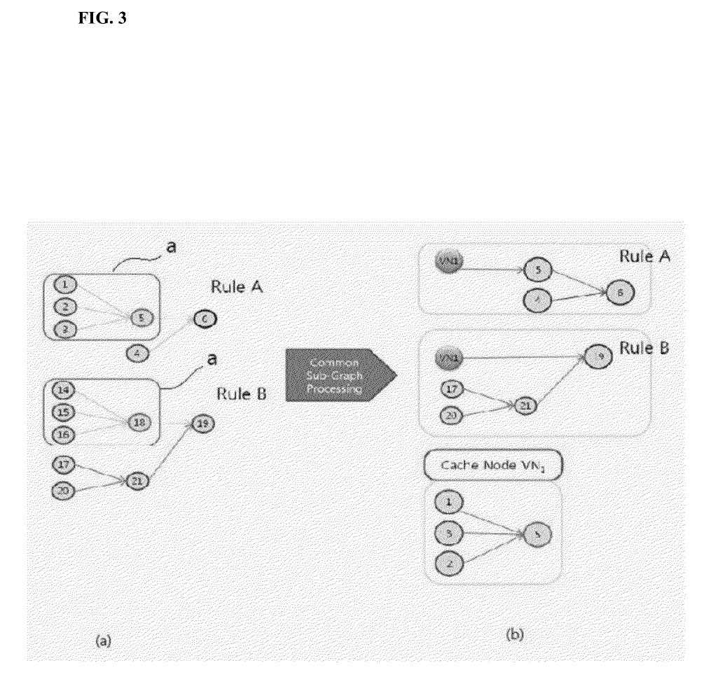

FIG. 2 is a diagram illustrating a method for dynamically updating an event configuration rule for processing a complex event in accordance with an embodiment of the present invention, and FIGS. 3 to 5 are exemplary diagrams illustrating the method for dynamically updating an event configuration rule.

Referring to FIG. 2, the system analyzes an event configuration rule at step S202 and determines whether a redundant factor is present based on a result of the analysis at step S204. In this case, the system searches the graph data of the event configuration rule for a common sub-graph and determines that a redundant factor is present if, as a result of the search, the common sub-graph is found to be present.

If, as a result of the determination at step S204, the redundant factor is found to be present, the system changes the redundant factor to a new virtual rule node at step S206 and generates an event rule by combining the new virtual rule node with a non-redundant factor of the graph data at step S208.

Thereafter, the system sequentially compares the new virtual rule node with a set of previously stored virtual rule nodes and determines whether the new virtual rule node is present in the set of virtual rule nodes based on a result of the comparison at step S210.

If, as a result of the determination at step S210, the new virtual rule node is determined to be present in the set of virtual rule nodes, the system segments and reconfigures a corresponding virtual rule node and stores the segmented and reconfigured virtual rule node at step S212.

If, as a result of the determination at step S210, the new virtual rule node is determined to be not present in the set of virtual rule nodes, the system adds the new virtual rule node to the set of virtual rule nodes at step S214.

Accordingly, the usability of an event configuration rule can be significantly improved, and event processing efficiency can be guaranteed.

A method for dynamically updating, by the system, an event configuration rule is described below with reference to FIG. 3.

If redundant factors “a” are retrieved as a result of an analysis of a rule A and a rule B, that is, event configuration rules, as illustrated in FIG. 3(a), the system stores the redundant factor “a” in the storage unit as a new virtual rule node VN₁ as illustrated in FIG. 3(b) and applies the new virtual rule node VN₁ to the rule A and the rule B.

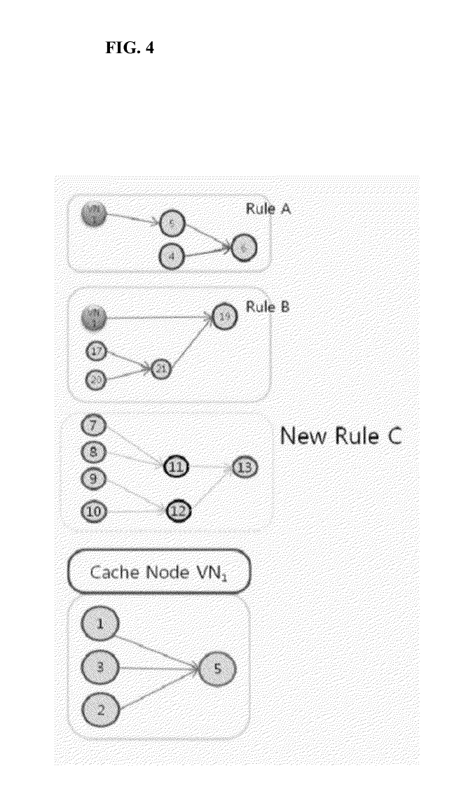

If a rule C, that is, a new event configuration rule, is input in the state in which a set of the virtual rule nodes has been stored in the storage unit as illustrated in FIG. 4, the system searches for a redundant factor by comparing the rule C with the rule A and the rule B.

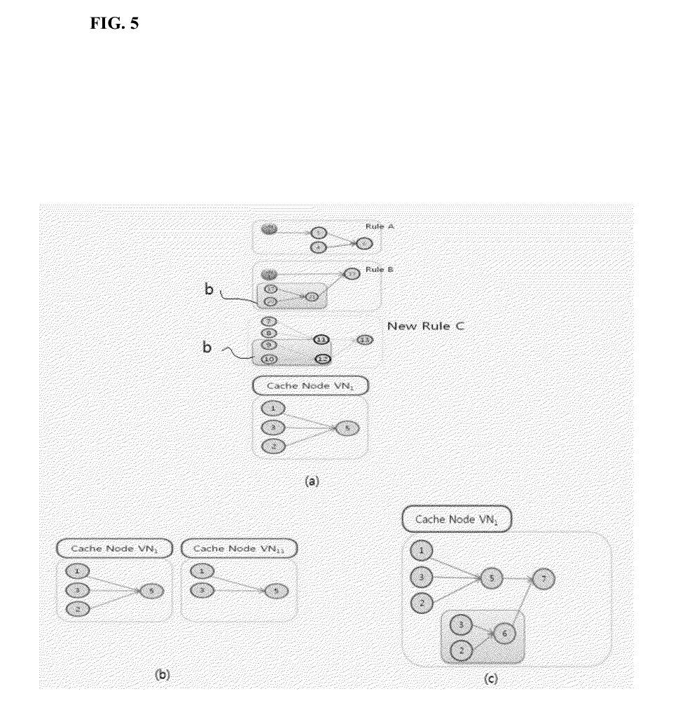

If a redundant factor “b” is retrieved as a result of the search for the redundant factor as illustrated in FIG. 5(a), the system determines whether the same redundant factor as the redundant factor “b” is present in the set of virtual rule nodes stored in the storage unit.

If, as a result of the determination, the same redundant factor as the redundant factor “b” is determined to be not present in the set of virtual rule nodes stored in the storage unit, the system stores the redundant factor “b” in the storage unit as a virtual rule node VN₁₁ as illustrated in FIG. 5(b).

If, as a result of the determination, the same redundant factor as the redundant factor “b” is determined to be present in the set of virtual rule nodes stored in the storage unit, the system segments and reconfigures the virtual rule node VN₁ and stores the segmented and reconfigured virtual rule node VN₁ and a virtual rule node VN₂ as illustrated in FIG. 5(c).

The method for dynamically updating an event configuration rule for processing a complex event described so far in accordance with an embodiment of the present invention may be implemented in the form of a program, application, or system file for executing the method. The present invention may be implemented in the form of a computer-readable recording medium on which such a program has been recorded.

Such a method for dynamically updating an event configuration rule for processing a complex event may be written in a program form, and codes and code segments that form the program may be easily deduced by a programmer skilled in the art. Furthermore, a program regarding the method for dynamically updating an event configuration rule for processing a complex event may be stored in a readable medium readable by an electronic device and may be read and executed by an electronic device.

As described above, in accordance with the present invention, a configuration rule that is frequently used to reuse an event configuration rule used to process a complex event is configured and templated in the form of a virtual rule node. Accordingly, the number of operations and the time taken to process all the processes can be reduced. Furthermore, the usability of a rule configuration for rapid complex event processing based on a large amount of data can be improved and a processing time can be reduced using a processing method for reconfiguring a virtual rule node by dynamically optimizing an event configuration rule when an additional event configuration rule is given.

Furthermore, there are advantages in that the processing speed of a complex event can be improved and usability can be improved because an event configuration rule frequently used in the processing of a complex event is reused.

As described above, those skilled in the art to which the present invention pertains will understand that the present invention may be implemented in various detailed forms without changing the technical spirit or indispensable characteristics of the present invention. It will be understood that the aforementioned embodiments are illustrative and not limitative from all aspects. The scope of the present invention is defined by the appended claims rather than the detailed description, and the present invention should be construed as covering all modifications or variations derived from the meaning and scope of the appended claims and their equivalents.

What is claimed is:

1. A system for dynamically updating an event configuration rule for processing a complex event, the system comprising:
an analysis unit configured to analyze an event configuration rule, change a redundant factor to a new virtual rule node, and generate an event rule by combining the new virtual rule node with a non-redundant factor; and
an update unit configured to sequentially compare the new virtual rule node with a set of previously stored virtual rule nodes and segment and reconfigure the new virtual rule node or the set of virtual rule nodes based on a result of the comparison.

2. The system of claim 1, further comprising a virtual node storage unit configured to store a virtual rule node of a redundant event configuration rule.

3. The system of claim 1, wherein the analysis unit searches for a common sub-graph based on a number and IDs of adjacent nodes in each node of graph data of the event configuration rule and uses the retrieved common sub-graph as the redundant factor.

4. The system of claim 1, wherein:
the update unit segments and reconfigures a corresponding virtual rule node if the new virtual rule node is present in the set of virtual rule nodes, and
the update unit adds the new virtual rule node to the set of virtual rule nodes if the new virtual rule node is not present in the set of virtual rule nodes.

5. A method for dynamically updating an event configuration rule for processing a complex event, the method comprising:
analyzing an event configuration rule, changing a redundant factor to a new virtual rule node, and generating an event rule by combining the new virtual rule node with a non-redundant factor; and
sequentially comparing the new virtual rule node with a set of previously stored virtual rule nodes and segmenting and reconfiguring the new virtual rule node or the set of virtual rule nodes based on a result of the comparison.

6. The method of claim 5, wherein analyzing the event configuration rule, changing the redundant factor to the new virtual rule node, and generating the event rule by combining the new virtual rule node with the non-redundant factor comprises:
searching for a common sub-graph based on a number and IDs of adjacent nodes in each node of graph data of the event configuration rule and changing the retrieved common sub-graph to the new virtual rule node; and
generating the event rule by combining the new virtual rule node with the non-redundant factor of the graph data.

7. A computer-readable recording medium on which a method for dynamically updating an event configuration rule for processing a complex event has been recorded in a program form, wherein the method comprises:
analyzing an event configuration rule, changing a redundant factor to a new virtual rule node, and generating an event rule by combining the new virtual rule node with a non-redundant factor; and
sequentially comparing the new virtual rule node with a set of previously stored virtual rule nodes and segmenting and reconfiguring the new virtual rule node or the set of virtual rule nodes based on a result of the comparison.
